(19) United States
(12) Patent Application Publication
(10) Pub. No.: US 2018/0121753 A1
(43) Pub. Date: May 3, 2018

(54) METHOD FOR RADIO FREQUENCY INTERFERENCE DIRECT DETECTION AND DATA RECOVERY BASED ON THE HILBERT-HUANG TRANSFORMATION FOR 2-D

(71) Applicant: U.S.A. as represented by the Administrator of the National Aeronautics and Space Administration, Washington, DC (US)

(72) Inventor: SEMION KIZHNER, REISTERSTOWN, MD (US)

(21) Appl. No.: 15/341,833

(22) Filed: Nov. 2, 2016

(51) Int. Cl. G06K 9/50; G06K 9/46

(52) U.S. Cl. CPC G06K 9/50; G06K 9/4647

(57) ABSTRACT

Various embodiments relate to an apparatus, method and a non-transitory computer readable medium for detecting radio-frequency interference (RFI) and recovering image data in the RFI using Hilbert-Huang Transform (“HHT2-RFI”) configured to apply Empirical Mode Decomposition (“EMD2”) to decompose image data into a plurality of bi-dimensional intrinsic mode functions (“BIMFs”), determine a RFI by entropic interpretation, augment the RFI by applying Hilbert Spectral Analysis (“HSA2”) to the RFI resulting in RFI data points and perform science data recovery by subtracting the amplitudes of the RFI and the RFI data points from the image data.

### RELATED APPLICATIONS

U.S. Pat. No. 9,013,490 describes a Hilbert-Huang transform data processing real-time system with 2-D capabilities which is hereby incorporated by reference for all purposes as if fully set forth herein.

### ORIGIN OF THE INVENTION

The invention described herein was made by an employee of the United States Government, and may be manufactured and used by or for the Government for Government purposes without the payment of any royalties thereon or therefore.

### TECHNICAL FIELD

This disclosure relates generally to detection and mitigation of radio frequency interference (“RFI”), and more specifically, but not exclusively, to utilizing the 2-D Hilbert-Huang Transformation (“HHT2”) to detect and mitigate radio frequency interference.

### BACKGROUND

Advanced spacecraft passive microwave radiometry uses natural thermal emissions to remotely sense Earth phenomena, particularly in the L-band surface moisture. A terrestrial L-band signal-to-space suffers less attenuation by the intervening canopy or atmosphere.

Relative insensitivity of the L-band region to atmospheric effects also makes it an attractive spectral range for wireless radar and cellular communications, which cause RFI with spaceflight science radiometer instrument's terrestrial signal of interest.

The one dimensional Hilbert-Huang Transform (“HHT1”) data processing system includes two components, namely, the 1-D Empirical Mode Decomposition (“EMD1”) and the 1-D Hilbert Spectral Analyses (“HSA1”)

HHT1={EMD1, HSA1} (1)

Implementation of the HHT for 2-D has been hindered by two challenges, namely, the computational complexity of 2-D Empirical Mode Decomposition (“EMD2”) and the absence of a viable HSA2.

The present technique for spectral analysis is the Napoleonic Times Fourier Transform (FT) or the recent digital fast implementations for 1-D and 2-D (“FFT1”, “FFT2”).

The digital implementation of HHT and EMD involves building the input signal's upper and lower signal envelopes using signal maxima and minima extrema points and cubic splines of considerable computational complexity.

The FT makes assumption that its input signal is linear and stationary and meets the Dirichlet conditions. However, the evolving HHT is an empirical technique and as such, it has certain limitations, such as its computational complexity.

Presently, there is technology which detects many types of RFI events and deletes the entire RFI-contaminated measurement point, which results in approximately 12% data loss.

Therefore, there is a need for an effective computational method of detecting the RFI, excision of just the RFI-contaminated component from the composite signal and recovering the measurements in the RFI.

### SUMMARY OF EMBODIMENTS

A brief summary of various embodiments is presented below. Embodiments address the need to detect RFI, excise of just the RFI-contaminated component from the composite signal and recover the measurements in the RFI based on HHT2 analysis and synthesis.

In order to overcome these and other shortcomings of the prior art and in light of the present need for a method to detect RFI, excise of just the RFI-contaminated component from the composite signal and recover the measurements in the RFI based on HHT2 analysis and synthesis, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a method of image data processing for detecting radio-frequency interference or RFI and recovering image data in the RFI using Hilbert-Huang Transform (“HHT2-RFI”), the method comprising applying Empirical Mode Decomposition (“EMD2”) to decompose image data into a plurality of bi-dimensional intrinsic mode functions (“BIMFs”), determining a RFI by entropic interpretation, augmenting the RFI by applying Hilbert Spectral Analysis (“HSA2”) to the RFI resulting in RFI data points and performing science data recovery by subtracting the amplitudes of the RFI and the RFI data points from the image data.

In an embodiment of the present disclosure the method further includes determining a RFI by interpreting the EMD2 BIMFs as frequency channel scales, determining common local maximas of at least one of the plurality of BIMFs, and determining whether the common local maximas intersect with a local maximas of a different one of the plurality of BIMFs.

In an embodiment of the present disclosure, an intersection of the local maximas indicates a RFI.

Various embodiments described herein relate to a non-transitory computer readable medium storing program code for detecting radio-frequency interference (RFI) and recovering image data in the RFI using Hilbert-Huang Transform (“HHT2-RFI”), the program code being executable by a process to perform operations including applying Empirical Mode Decomposition (“EMD2”) to decompose image data into a plurality of bi-dimensional intrinsic mode functions (“BIMFs”), determining a RFI by entropic interpretation, augmenting the RFI by applying Hilbert Spectral Analysis (“HSA2”) to the RFI resulting in RFI data points and performing science data recovery by subtracting the amplitudes of the RFI and the RFI data points from the image data.

In an embodiment of the present disclosure the method further includes determining a RFI by interpreting the EMD2 BIMFs as frequency channel scales, determining common local maximas of at least one of the plurality of BIMFs, and determining whether the common local maximas intersect with a local maximas of a different one of the plurality of BIMFs.

In an embodiment of the present disclosure, an intersection of the local maximas indicates a RFI.

Various embodiments described herein relate to computing device detecting radio-frequency interference (RFI) and recovering image data in the RFI using Hilbert-Huang Transform (“HHT2-RFI”) including a processor, and a memory coupled to the processor and containing instructions that, when executed by the processor, perform a set of functions including applying Empirical Mode Decomposition (“EMD2”) to decompose image data into a plurality of bi-dimensional intrinsic mode functions (“BIMFs”), determining a RFI by entropic interpretation, augmenting the RFI by applying Hilbert Spectral Analysis (“HSA2”) to the RFI resulting in RFI data points and performing science data recovery by subtracting the amplitudes of the RFI and the RFI data points from the image data.

In an embodiment of the present disclosure the method further includes determining a RFI by interpreting the EMD2 BIMFs as frequency channel scales, determining common local maximas of at least one of the plurality of BIMFs, and determining whether the common local maximas intersect with a local maximas of a different one of the plurality of BIMFs.

In an embodiment of the present disclosure, an intersection of the local maximas indicates a RFI.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

These and other more detailed and specific features of the present invention are more fully disclosed in the following specification, reference being had to the accompanying drawings, in which:

FIG. 1 illustrates a graph for HHT signal decomposition and RFI-like variations spectrum.

FIG. 2 illustrates a flow diagram for detecting RFI and recovering image data in the RFI using HHT2-RFI, according to an embodiment; and

FIG. 3 illustrates a block diagram of a real-time data processing system with 2-D capabilities, according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. Descriptors such as “first,” “second,” “third,” etc., are not meant to limit the order of elements discussed, are used to distinguish one element from the next, and are generally interchangeable.

The method for frequency interference detection, excision, and recovery uses the Hilbert-Huang Transform for 2-D or HHT2 and the Hilbert Spectral Analysis for 2-D (HSA2).

The method specifically uses HHT2-RFI for a direct decomposition of the RFI-contaminated signal into 2-D intrinsic mode functions (“BIMFs”) and uses BIMFs HSA2 for 2-D to recover the RFI-contaminated data points.

Radiometer measurement data can be processed with a developed engineering tool resulting in detecting most RFI-events and recovering the measurements in the RFI-events contaminated data points.

By using this method, HHT2-RFI recovers approximately 12% of previously lost data points.

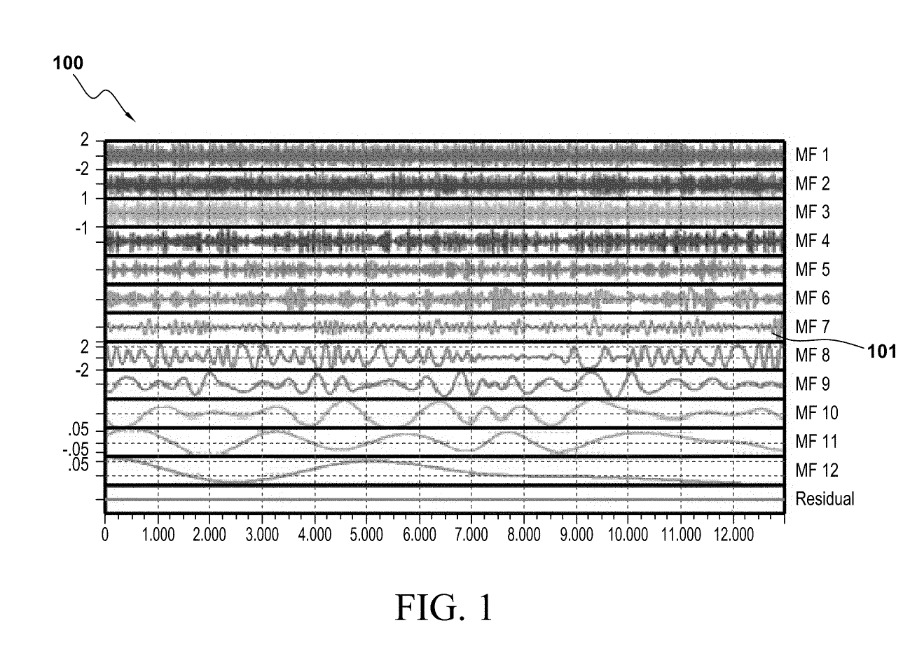

FIG. 1 illustrates a graph 100 for HHT signal decomposition and RFI-like spectrum. The input data contains length of Earth day in microseconds using atomic clocks and astronomical observations to measure each day length.

The deviation of this data from the standard 86,400 seconds length of day was processed by the HHT1 and resulted in a rich spectrum of data in IMF 7 101. These spectral components were not visible using spectral analysis tools, such as FFT.

Similarly, when a 2-D image is processed by HHT2, spectral compositions, such as presence of RFI variations are discoverable.

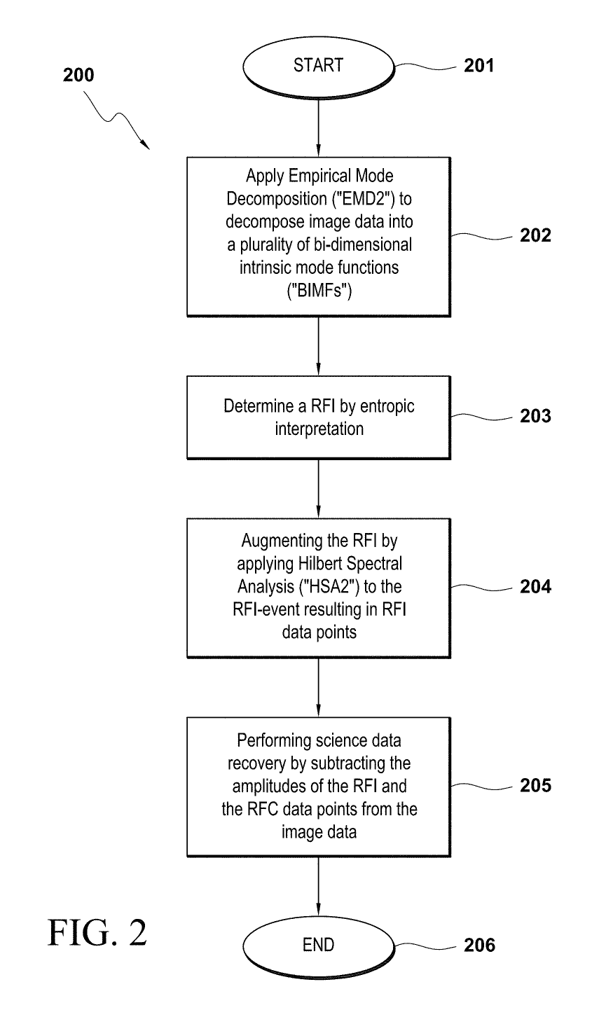

FIG. 2 illustrates a HHT2-RFI method 200 with 2-D capabilities, according to an embodiment. The method of FIG. 1 may be executed by, for example, the computing system shown in FIG. 2. This execution may be in real time or near real time.

The HHT2-RFI method 200 begins at step 201 which begins the HHT2-RFI method 200.

The HHT2-RFI method 200 continues to step 202 which applies the EMD2 to decompose image data into a plurality of BIMFs. The EMD2 discriminates man-made signals from signals occurring due to natural phenomenon.

The HHT2-RFI method 200 continues to step 203 which determines a RFI by entropic interpretation.

The HHT2-RFI method 200 continues to step 204 which augments the RFI by applying Hilbert Spectral Analysis (“HSA2”) to the RFI-event resulting in RFI data points. These RFI data points are outside of the frequencies of interest.

The RFI is determined by the EMD2 and the RFI data points are determined by the HSA2.

The HHT2-RFI method 200 continues to step 205 which performs science data recovery by subtracting the amplitudes of the RFI and the RFI data points from the image data. The data point indices of the RFI and the RFI data points are totaled and subtracted from the image data.

In order to receive positive frequencies, it is required to first apply to an input the EMD to obtain IMFs or BIMFs, and then apply to the IMFs or BIMFs, the Hilbert Transform. Only this order will yield the expected positive frequencies.

In another embodiment, EMD2 is used to decompose an image into its 2-D BIMFs and BIMF basis can be analyzed for RFI components by interpreting the EMD2 BIMFs as frequency channel scales, determining common local maximas of at least one of the plurality of BIMFs, and determining whether the common local maximas intersect with a local maximas of a different one of the plurality of BIMFs, where an intersection of the local maximas indicates a RFI.

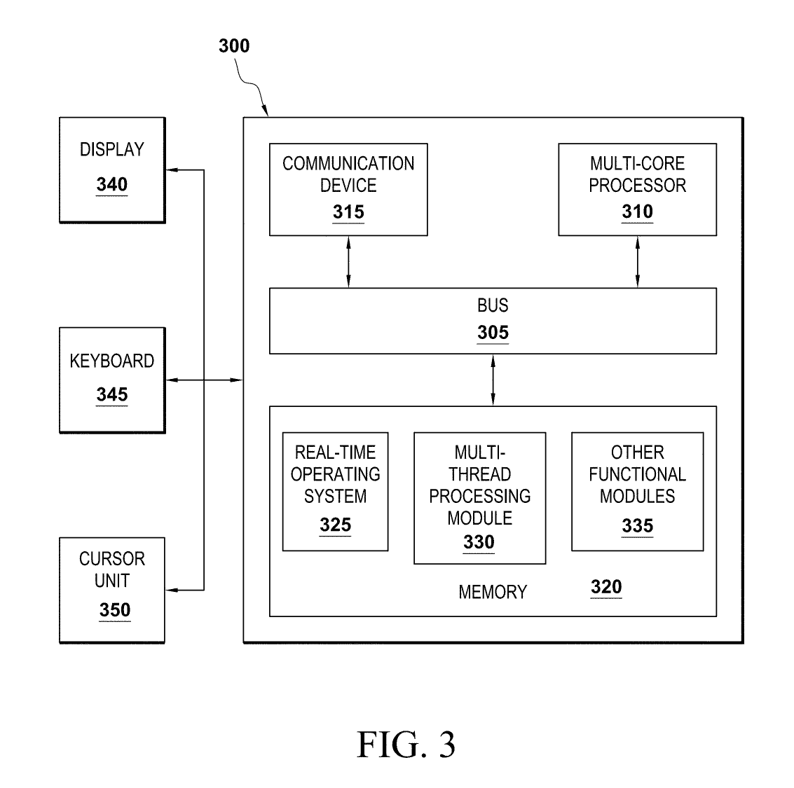

FIG. 3 illustrates a block diagram of a real-time data processing system 300 with 2-D capabilities, according to an embodiment of the present invention. System 300 may include a bus 305 or other communication mechanism that can communicate information and a processor 310, coupled to bus 305 that can process information. Processor 310 can be any type of general or specific purpose processor. System 300 may also include memory 320 that can store information and instructions to be executed by processor 310. Memory 320 can include any combination of random access memory (“RAM”), read only memory (“ROM”), static storage such as a magnetic or optical disk, or any other type of computer-readable medium. System 300 may also include a communication device 315, such as a network interface card, that may provide access to a network.

The computer-readable medium may be any available media that can be accessed by processor 310. The computer-readable medium may include both volatile and nonvolatile medium, removable and non-removable media, and communication media. The communication media may include computer-readable instructions, data structures, program modules, or other data and may include any information delivery media.

Processor 310 can also be coupled via bus 305 to a display 340, such as a Liquid Crystal Display (“LCD”). Display 340 may display information to the user. A keyboard 345 and a cursor control unit 350, such as a computer mouse, may also be coupled to bus 305 to enable the user to interface with system 300.

According to one embodiment, memory 320 may store software modules that may provide functionality when executed by processor 310. The modules can include an operating system 325 and a processing module 330, as well as other functional modules 335. Operating system 325 may provide operating system functionality for system 300. Because system 300 may be part of a larger system, system 300 may include one or more additional functional modules 335 to include the additional functionality.

It should be apparent from the foregoing description that various embodiments of the invention may be implemented in hardware. Furthermore, various embodiments may be implemented as instructions stored on a non-transitory machine-readable storage medium, such as a volatile or non-volatile memory, which may be read and executed by at least one processor to perform the operations described in detail herein. A non-transitory machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media and excludes transitory signals.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may include one or more generic or specialized processors (or “processing devices”) such as non-general purpose microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of image data processing for detecting radio-frequency interference (RFI) and recovering image data in the RFI using Hilbert-Huang Transform (“HHT2-RFI”), the method comprising:
applying Empirical Mode Decomposition (“EMD2”) to decompose image data into a plurality of bi-dimensional intrinsic mode functions (“BIMFs”);
determining a RFI by entropic interpretation;
augmenting the RFI by applying Hilbert Spectral Analysis (“HSA2”) to the RFI resulting in RFI data points;
performing science data recovery by subtracting the amplitudes of the RFI and the RFI data points from the image data.

2. The method of claim 1, further comprising determining a RFI by interpreting the EMD2 BIMFs as frequency channel scales, determining common local maximas of at least one of the plurality of BIMFs, and determining whether the common local maximas intersect with a local maximas of a different one of the plurality of BIMFs.

3. The method of claim 2, wherein an intersection of the local maximas indicates a RFI.

4. A non-transitory computer readable medium storing program code for detecting radio-frequency interference (RFI) and recovering image data in the RFI using Hilbert-Huang Transform (“HHT2”)-RFI, the program code being executable by a process to perform operations comprising:
applying Empirical Mode Decomposition (“EMD2”) to decompose image data into a plurality of bi-dimensional intrinsic mode functions (“BIMFs”);
determining a RFI by entropic interpretation;
augmenting the RFI by applying Hilbert Spectral Analysis (“HSA2”) to the RFI resulting in RFI data points;
performing science data recovery by subtracting the amplitudes of the RFI and the RFI data points from the image data.

5. The non-transitory computer readable medium of claim 4, further comprising determining a RFI by interpreting the EMD2 BIMFs as frequency channel scales, determining common local maximas of at least one of the plurality of BIMFs, and determining whether the common local maximas intersect with a local maximas of a different one of the plurality of BIMFs.

6. The non-transitory computer readable medium of claim 5, wherein an intersection of the local maximas indicates a RFI.

7. A computing device detecting radio-frequency interference (RFI) and recovering image data in the RFI using Hilbert-Huang Transform (“HHT2-RFI”) comprising:
a processor, and
a memory coupled to the processor and containing instructions that, when executed by the processor, perform a set of functions including:
applying Empirical Mode Decomposition (“EMD2”) to decompose image data into a plurality of bi-dimensional intrinsic mode functions (“BIMFs”);
determining a RFI by entropic interpretation;
augmenting the RFI by applying Hilbert Spectral Analysis (“HSA2”) to the RFI resulting in RFI data points;
performing science data recovery by subtracting the amplitudes of the RFI and the RFI data points from the image data.

8. The computing device of claim 7, further comprising determining a RFI by interpreting the EMD2 BIMFs as frequency channel scales, determining common local maximas of at least one of the plurality of BIMFs, and determining whether the common local maximas intersect with a local maximas of a different one of the plurality of BIMFs.

9. The computing device of claim 8, wherein an intersection of the local maximas indicates a RFI.
